(19) United States
(12) Patent Application Publication
(10) Pub. No.: US 2005/0083416 A1
(43) Pub. Date: Apr. 21, 2005

(54) Method for managing data files in portable digital apparatus utilizing date data and portable digital apparatus using the method

(75) Inventor: Dae-jin Jeon, Changwon-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/960,410

(22) Filed: Oct. 7, 2004

(30) Foreign Application Priority Data
Oct. 15, 2003 (KR) 2003-71879

(51) Int. Cl. H04N 5/76

(52) U.S. Cl. 348/231.3

(57) ABSTRACT

A method for managing data files of a user in a portable digital apparatus having a recording medium and a display apparatus is provided. The method includes generating a directory and storing a data file. In generating the directory, a date directory having a name containing a current date is generated on the recording medium. In storing the data file, if a data file of the user is generated, the generated data file is stored in the date directory.

### BACKGROUND OF THE INVENTION

This application claims the priority of Korean Patent Application No. 2003-71879, filed on Oct. 15, 2003, in the Korean Intellectual Property Office, the disclosure of which is incorporated herein in its entirety by reference.

1. Field of the Invention

The present invention relates to a method for managing data files of a user in a portable digital apparatus and a portable digital apparatus using the method, and more particularly, to a method for managing data files of a user in a portable digital apparatus, for example, a digital camera, which has a display apparatus and in which a recording medium can be inserted and removed, and a portable digital apparatus using the method.

2. Description of the Related Art

A conventional portable digital apparatus has limitations in user input functions, such that a user frequently finds it difficult to manage data files. Accordingly, from the perspective of the user, there are problems as follows.

First, a user is required to use another apparatus, such as a personal computer, in order to manage data files generated in the portable digital apparatus.

Secondly, the user is usually required to reproduce all data files in order to find a particular data file among the data files stored in a recording medium. For example, in the case of a digital camera, the user frequently has to reproduce all the data files in order to find a particular data file among data files stored in a recording medium.

U.S. Pat. No. 5,861,918 teaches where, when a recording medium is inserted into a digital camera, a single directory is generated and user data files are stored only in this single directory. Accordingly, even when the recording medium is used in another digital camera, file name conflicts related to storage paths can be prevented. However, if a large number of data files of a user are stored in a single directory, problems such as those described above can occur.

### SUMMARY OF THE INVENTION

The present invention provides a method for managing data files in a portable digital apparatus enabling a user to be able to easily manage data files of the user without using another apparatus, and a portable digital apparatus using the method.

According to an aspect of the present invention, there is provided a method and apparatus for managing data files of a user in a portable digital apparatus having a recording medium and a display apparatus, the method including generating a directory and storing a data file. In generating the directory, a date directory having a name containing a current date may be generated on the recording medium. In storing the data file, if a data file of the user is generated, the generated data file may be stored in the date directory.

According to the method for managing data files and the portable digital apparatus of the present invention, the data files are classified and stored in a date directory having a name containing the date of each file. Accordingly, date directories and their data files can be displayed in the portable digital apparatus such that the user of the portable digital apparatus can easily manage the data files of the user without using another apparatus.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view showing the external shape of the front and upper part of a digital camera as a portable digital apparatus according to the present invention;

FIG. 2 is a back view showing the external shape of the back part of the digital camera of FIG. 1;

FIG. 3 is a block diagram showing the entire structure of the digital camera of FIG. 1;

FIG. 4 is a flowchart showing a data-file storing algorithm of a digital camera processor of FIG. 3; and

FIG. 5 is a block diagram showing a data-file storage structure by execution of the algorithm of FIG. 4.

### DETAILED DESCRIPTION OF THE INVENTION

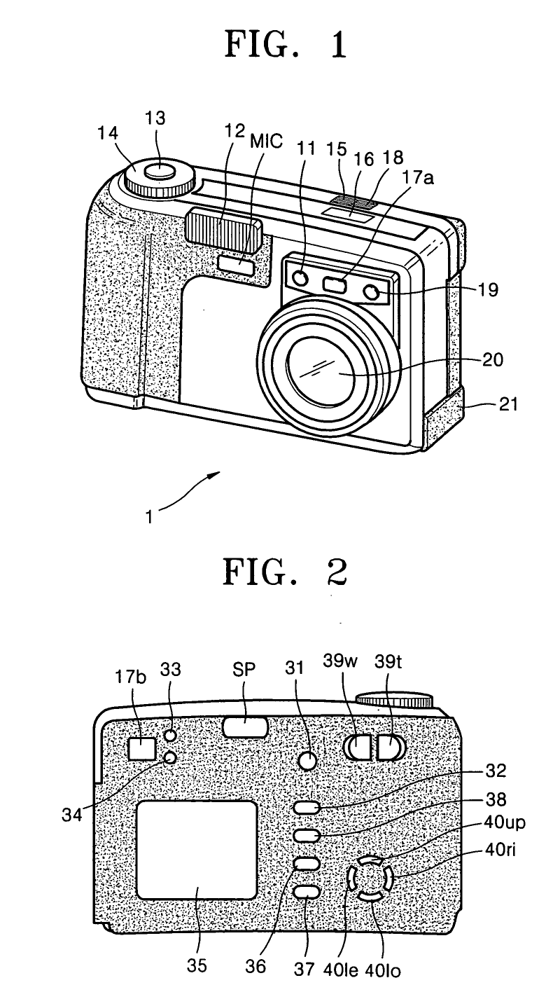

FIG. 1 illustrates a portable digital apparatus in the form of a digital camera in accordance with the present invention. On the front and upper part of the digital camera 1 according to the present invention, there is a microphone (MIC), a self-timer lamp 11, a flash 12, a shutter button 13, a mode dial 14, a function-selection button 15, a photographing-information display unit 16, a view finder 17A, a function-block button 18, a flash-light sensor 19, a lens unit 20, and an external interface unit 21.

In self-timer mode, the self-timer lamp 11 operates during a preset time from a time when the shutter button 13 is pushed to a time when the shutter operates.

The mode dial 14 is used by a user in order to select and set any one of still image photographing mode, night scene photographing mode, moving picture photographing mode, reproduction mode, computer connection mode, and system setting mode.

The function-selection button 15 is used by the user in order to select any one of operation-display modes, for example, preview-display mode for the photographing modes and reproduction-display mode, of the digital camera 1. On the photographing-information display unit 16, various information related to photographing is displayed. When there is a state display panel (there isn't in the present embodiment), which displays the operation state of each function, the function-block button 18 is used by the user to select each function.

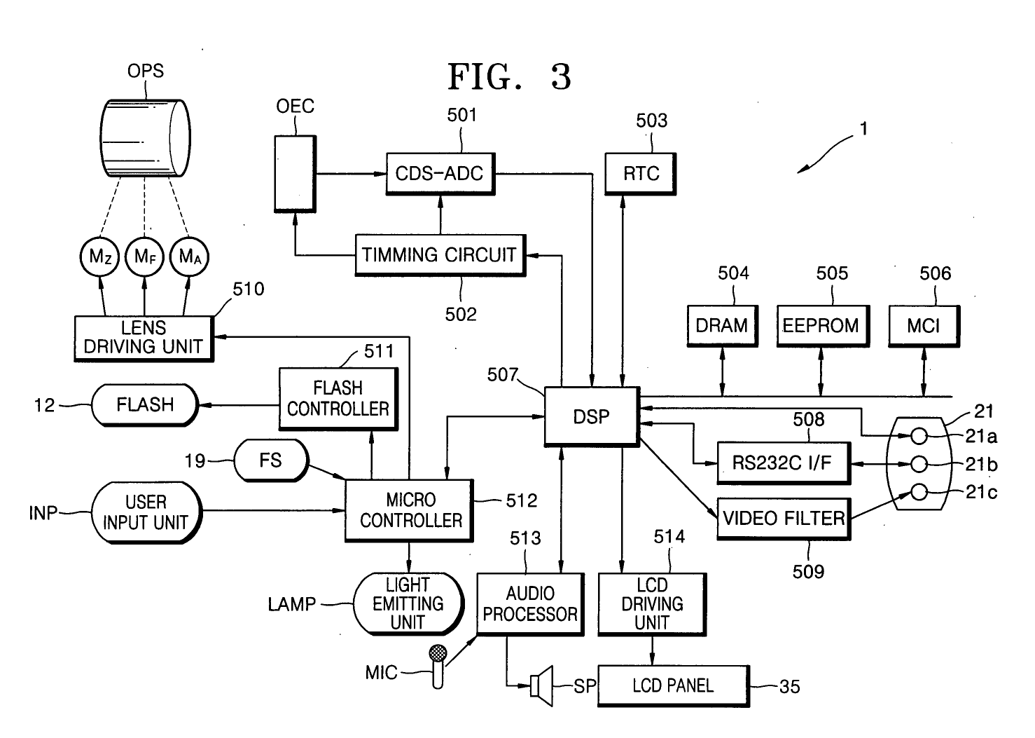

Referring to FIG. 2, at the back of the digital camera 1 according to the present invention, there are a speaker (SP), a power button 31, a monitor button 32, an auto-focus lamp 33, a view finder 17B, a flash wait lamp 34, a display panel 35, a confirm/delete button 36, an enter/reproduction button 37, a menu button 38, a wide angle-zoom button 39W, a telephoto-zoom button 39T, an up-movement button 40UP, a right-movement button 40RI, a down-movement button 40LO, and a left-movement button 40LE.

The monitor button 32 is used by the user to control the operation of the display panel 35. For example, if the user pushes the monitor button 32 first time, the photo of an object and related photographing information are displayed on the display panel 35, and if the user pushes secondly, only the photo of the object is displayed on the display panel 35, and if the user pushes thirdly, power being provided to the display panel 35 is cut off. The auto-focus lamp 33 operates when the focus is well adjusted. The flash wait lamp 34 operates when the flash (12 of FIG. 1) is in an operation wait state. The confirm/delete button 36 is used as a confirm button or a delete button in a process when the user sets each mode.

The enter/reproduction button 37 is used for inputting data from the user, or for functions of still or reproduction in reproduction mode. The menu button 38 is used to display the menu of a mode selected in the mode dial 14. The up-movement button 40UP, the right-movement button 40RI, the down-movement button 40LO, and the left-movement button 40LE are also used in the process when the user sets each mode.

Referring to FIGS. 1 through 3, the entire structure of the digital camera 1 of FIG. 1 will now be explained.

An optical system (OPS) including a lens unit (not shown) and a filter unit (not shown) optically processes light from an object.

If the user pushes the wide angle-zoom button 39W or the telephoto-zoom button 39T included in the user input unit (INP), a signal corresponding to the pushing is input to the microcontroller 512. According to this, the microcontroller 512 controls the lens driving unit 510, which in turn drives a zoom motor (M_{Z}) and a zoom lens (not shown) in the optical system (OPS) moves. That is, if the wide angle-zoom button 39W is pushed, the focal length of the zoom lens is shortened and the picture angle is widened, and if the telephoto-zoom button 39W is pushed, the focal length of the zoom lens is lengthened and the picture angle is narrowed.

Meanwhile, if the focus of the object is automatically or manually adjusted, the current position of the focus lens (not shown) in the optical system (OPS) varies in relation with the distance to the object. In the auto focus mode, the focus motor (M_{F}) is driven by the microcontroller 512 controlling the lens driving unit 510. According to this, the focus lens moves, and in this moving process, the position of the focus lens at which the high frequency component of the image signal becomes the most, for example, the number of driving steps of the focus motor (M_{F}), is set.

Reference symbol M_{A} indicates a motor for driving an aperture (not shown).

A charge coupled device (CCD) or an opto electronic conversion unit (OEC) of a complementary metal-oxide semiconductor (CMOS) converts light from the optical system (OPS) into an electric analog signal. Here, a digital camera processor 507 controls a timing circuit 502 such that the operations of the OEC and a correlation double sampler and analog-to-digital converter (CDS-ADC) device, as an analog-digital conversion unit, are controlled. The CDS-ADC device 501 processes an analog signal from the OEC, removes the high frequency noise in the signal, adjusts the amplitude, and then converts the signal into a digital signal.

A digital signal processor 507 has an embedded main controller, and performs the entire control according to timing signals from a real time clock (RTC) 503, a timing signal generator. The digital signal processor 507 processes the digital image signal from the CDS-ADC device 501 and generates a digital image signal divided into a luminance signal and a chrominance signal. This digital image signal is converted into a signal in the form of an analog composite video signal, and the converted analog composite video signal is displayed in a color LCD panel 35 through an LCD driving unit 514.

The digital image signal from the digital signal processor 507 is temporarily stored in a dynamic random access memory (DRAM) 504. In an erasable programmable read only memory (EPROM) 505, algorithms and preset data required for operations of the digital signal processor 507 are stored. A memory card as a recording medium of the user is inserted into a memory card interface 506 or separated from the memory card interface 506 by manipulation of the user. In this memory card, still images or moving picture files and audio files compressed by the digital signal processor 507 are stored. For reference, an embedded-type recording medium can be used in place of the memory card.

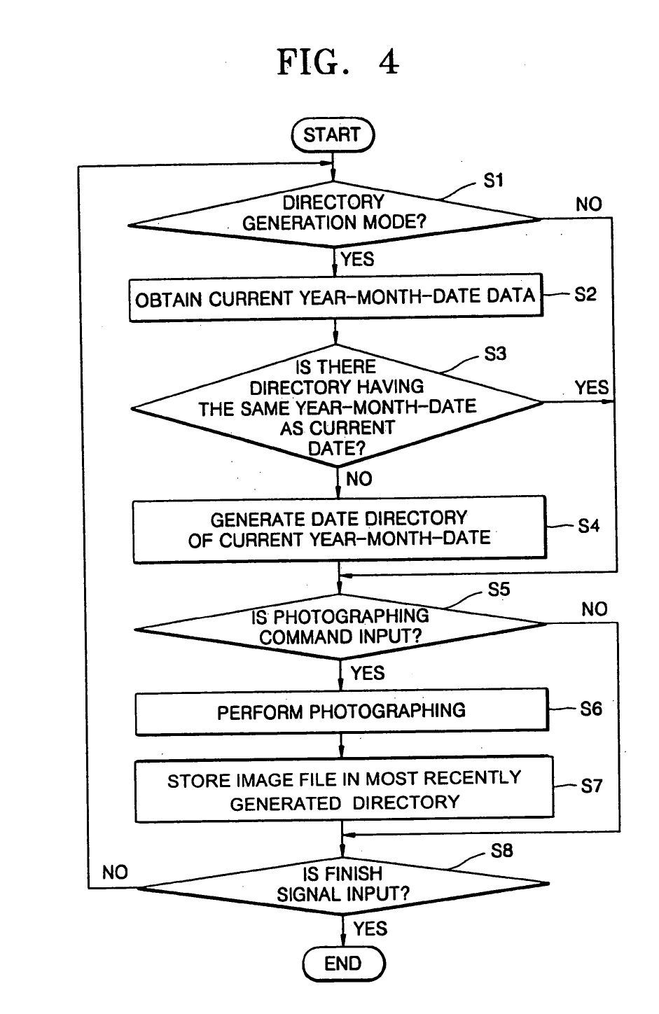

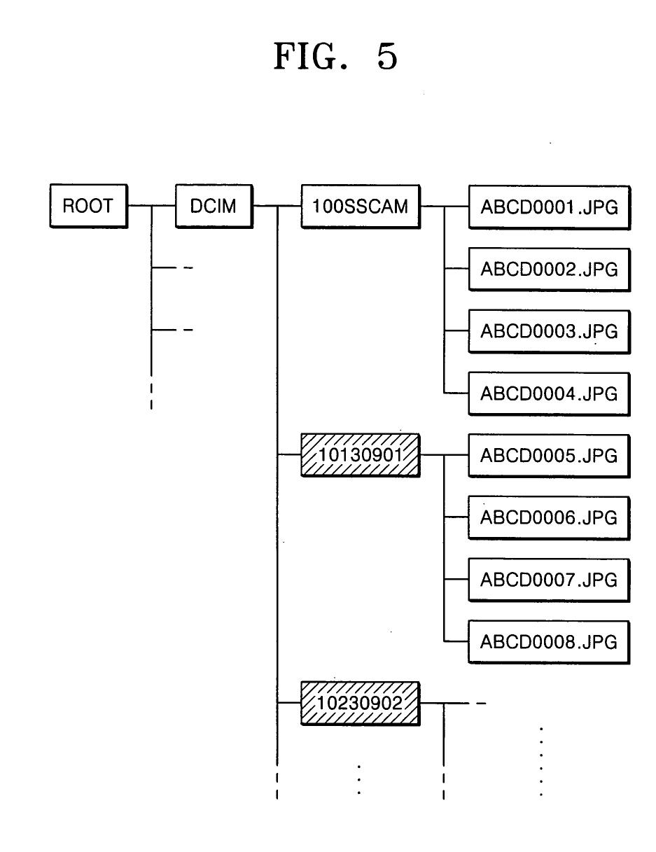

Here, if the driving power is turned on, the digital signal processor 507 automatically confirms whether or not the operation mode is directory generation mode, and if the mode is the directory generation mode, generates a date directory with a name containing a current date according to date data from the RTC 503, in the memory card as a recording medium. Here, only when the current date data is not included in names of the directories already generated in the recording medium, the date directory is generated in the recording medium. Accordingly, only one date directory can be generated in one day. Also, if a data file of the user is generated, the generated data file is stored in the date directory. That is, the data files are classified and stored in a date directory having a name containing the date of each file. Accordingly, date directories and their data files can be displayed in the LCD panel 35 such that the user of the digital camera 1 can easily manage the data files of the user without using another apparatus. Of course, the generated date directories can also be deleted by the user. An algorithm of the digital signal processor 507 related to the directory generation and image storing process will be explained in more detail with reference to FIGS. 4 and 5.

The light emitting unit (LAMP), which is driven by the microcontroller 512, includes the self-timer lamp 11, the auto-focus lamp 33, and the flash wait lamp 34. A user input unit (INP) includes the shutter button 13, the mode dial 14, the function-selection button 15, the function-block button 18, the monitor button 32, the confirm/delete button 36, the enter/reproduction button 37, the menu button 38, the wide angle-zoom button 39W, the telephoto-zoom button 39T, the up-movement button 40UP, the right-movement button 40RI, the down-movement button 40LO, and the left-movement button 40LE.

A digital image signal from the digital camera processor 507 is input to the LCD driving unit 514, and as a result, an image is displayed on the LCD panel 35. Also, the digital image signal from the digital camera processor 507 can be transmitted in a serial communication through a universal serial bus (USB) connection unit 21A or an RS232C interface 508 and its connection unit 21B, and can be transmitted as a video signal through a video filter 509 and a video output unit 21C.

The audio processor 513 outputs an audio signal from the microphone (MIC) to the digital camera processor 507 or the speaker (SP), and outputs an audio signal from the digital camera processor 507 to the speaker (SP).

Meanwhile, the microcontroller 512 controls the operation of the flash controller 511 according to a signal from the flash-light sensor 19 in order to drive the flash 12.

Referring to FIGS. 4 the directory generation and data file storing process of the digital camera processor 507 of FIG. 3 will now be explained.

If the driving power is turned on, in the initialization process of the digital camera processor 507, it is determined whether or not directory generation mode is set in step S1. If the directory generation mode is set by the user, the digital camera processor 507 performs steps S2 through S8 as follows. For example, by a user in a system setting process of the digital camera 1. The directory generation mode can be set. Of course, a separate dedicated button can also be used to set the directory generation mode. Meanwhile, if the power is turned off after setting the directory generation mode, setting of the directory generation mode can be reset or maintained.

First, the digital camera processor 507 obtains current year-month-date data from timing signals from the RTC 503 in step S2. Then, the digital camera processor 507 confirms whether or not the current year-month-date data is included in the names of directories already generated in the memory card. That is, it is confirmed whether or not there is a date directory having the same year-month-date as the current date in step S3. After the confirmation, only when there is no date directory having the same year-month-date as the current date, the digital camera processor 507 generates a date directory ( e.g., ‘10130901’ or ‘10230902’ of FIG. 5) of the current year-month-date in the memory card in step S4.

Next, if a photographing command signal is input to the digital camera processor 507 through the microcontroller 512 from the shutter button (13 of FIG. 1) included in the user input unit (INP) in step S5, the digital camera processor 507 performs a photographing operation in step S6.

In this photographing operation, the digital camera processor 507 operates the OEC unit and the CDS-ADC device 501 as the analog-digital conversion unit by controlling the timing circuit 502, and by processing the digital image signal from the CDS-ADC device 501, generates an image file of a digital image signal divided into a luminance signal and a chrominance signal. Next, in step 57, the digital camera processor 507 stores the generated image file in the most recently generated directory, i.e., the date directory of the current year-month-date generated in the memory card in the step S4.

The date directories and their data files can be displayed on the LCD panel 35 such that the user of the digital camera 1 can more easily manage the data files of the user without using another apparatus.

Meanwhile, if the directory generation mode is not set by the user in the step S1, the digital camera processor 507 does not perform steps S2 through S4 and, instead, performs steps S5 through S7. In this case, in the step S7, the image file is stored in a default directory (‘100SSCAM’ of FIG. 5).

FIG. 5 is a block diagram showing a data-file storage structure according to the process of FIG. 4.

Referring to FIG. 5, below the top directory “ROOT”, an upper directory “DCIM” for storing data files of the user is generated, and below “DCIM”, the default directory “100SSCAM” and date directories “10130901”, “10230902”, and so on are generated. Here, the first three digits “100”, “101”, and “102 indicate indexes according to the generation order of each directory. Also, 30901 in date directory “10130901” indicates Sep. 1, 2003. Likewise, 30902 in date directory “10230902” indicates Sep. 2, 2003.

Referring to FIGS. 4 and 5, when steps S2 through S4 are not performed, step S7 is performed such that user data files “ABCD0001.JPG” through “ABCD0004.JPG” are stored in default directory “100SSCAM”. Also, when the steps S2 through S4 are performed on Sep. 1, 2003, step S7 is performed such that user's data files “ABCD0005.JPG” through “ABCD0008.JPG” are stored in date directory “10130901”.

According to the method for managing data files and the portable digital apparatus of the present invention as described above, the data files are classified and stored in a date directory having a name containing the date of each file. Accordingly, date directories and their data files can be displayed in the portable digital apparatus such that the user of the portable digital apparatus can more easily manage the data files of the user without using another apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for managing data files of a user in a portable digital apparatus having a recording medium and a display, the method comprising:
generating a date directory having a name containing a current date on the recording medium; and
if a data file of the user is generated, storing the generated data file in the date directory.

2. The method of claim 1, wherein in generating the date directory in the recording medium, the date directory is generated according to selection of the user.

3. The method of claim 1, wherein in generating the date directory in the recording medium, only when the current date data is not included in the names of directories already generated in the recording medium, the date directory is generated in the recording medium.

4. A portable digital apparatus having a recording medium and a display apparatus, wherein a date directory having a name containing a current date is generated on the recording medium, and if a data file of the user is generated, the generated data file is stored in the date directory.

5. The portable digital apparatus of claim 4, wherein the recording medium is inserted into or removed from the portable digital apparatus by manipulation of the user.

6. The apparatus of claim 4, wherein only when the current date data is not included in the names of directories already generated in the recording medium, the date directory is generated in the recording medium.

7. A portable digital apparatus having a timing signal generator, a recording medium and a display, wherein if driving power is turned on, according to date data from the timing signal generator, a date directory having a name containing a current date is generated on the recording medium, and if a data file of the user is generated, the generated data file is stored in the date directory.

8. The apparatus of claim 7, wherein only when the current date data is not included in the names of directories already generated in the recording medium, the date directory is generated in the recording medium.

9. A method for storing data files generated by a portable digital apparatus having a recording medium and a display, the method comprising the steps:
using the portable digital apparatus to generate a data file to be stored on the recording medium,
obtaining the current date from the portable digital apparatus,
comparing the current date to the names of the set of directories available on the recording medium for storing data files,
if the current date matches the name of one of the directories on the recording medium, storing the generated data file in the matching directory,
if the current data does not match the name of one of the directories available on the recording medium, generating a new directory having a name containing the current date and storing the generated data file in the new directory.

10. The method according to claim 9 further comprising the steps of:
determining whether the user has specified whether a data directory or a default directory on the recording medium should be used for storing data files, and
if a default directory has been specified, storing the data file in a default directory.
